(19) United States
(12) Patent Application Publication
(10) Pub. No.: US 2026/0032697 A1
(43) Pub. Date: Jan. 29, 2026

(54) FREQUENCY DOMAIN ADAPTIVE RESOURCE CONFIGURATION FOR MULTI-SLOT ALLOCATION

(71) Applicant: Telefonaktiebolaget LM Ericsson (publ), Stockholm (SE)

(72) Inventors: Bikramjit SINGH, RAASEPORI (FI); Jonas FRÖBERG OLSSON, LJUNGSBORO (SE); Alexey SHAPIN, Linköping (SE)

(73) Assignee: Telefonaktiebolaget LM Ericsson (publ), Stockholm (SE)

(21) Appl. No.: 18/997,837

(22) PCT Filed: Jul. 11, 2023
(86) PCT No.: PCT/SE2023/050732

§ 371 Date: Jan. 23, 2025

Related U.S. Application Data
(60) Provisional application No. 63/397,658, filed on Aug. 12, 2022.

(51) Int. Cl. H04W 72/232; H04W 72/0453; H04W 76/20

(52) U.S. Cl. CPC H04W 72/232; H04W 72/0453; H04W 76/20

(57) ABSTRACT

A communication device and a method operating by the device are provided for frequency domain adaptive resource configuration for multi-slot allocation. The method includes receiving a plurality of frequency adaptive multi-PxSCH configurations and a DCI. Then, the device uses parameters associated with a multi-PxSCH configuration of the plurality configurations based on the DCI.

### TECHNICAL FIELD

The present disclosure is related to wireless communication systems and more particularly to frequency domain adaptive resource configuration for multi-slot allocation.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

Extended Reality (“XR”) is a term for different types of realities and can refer to all real-and-virtual combined environments and human-machine interactions generated by computer technology and wearables. XR can include the following representative forms and the areas interpolated among them: Augmented Reality (“AR”); Mixed Reality (“MR”); and Virtual Reality (“VR”).

XR and Cloud Gaming (“CG”) are currently one of the most important 5G media applications under consideration in the industry. Below are traffic details for downlink (“DL”) XR traffic models.

AR and VR DL streams are described below. In some examples, an AR/VR DL single stream follows a generic single stream DL video traffic model with the parameters illustrated in FIG. 2. In additional or alternative examples, the AR/VR DL single stream follows a single stream DL video traffic model with the parameters illustrated in FIG. 3A multi-stream model is described below. In some examples, VR DL multi-streams follow a generic multi-streams DL traffic model illustrated in FIG. 4. In additional or alternative examples, two streams (e.g., video+audio/data) are modeled. The first stream (stream 1) can be a video stream that follows the generic single stream model illustrated in FIGS. 2-3. The second stream (stream 2) can be an audio/data stream with a periodic traffic illustrated by FIG. 5.

CG DL streams are described below. In some examples, the CG DL stream follows a generic single stream DL video traffic model with the parameters illustrated in FIG. 6. In additional or alternative examples, a CG DL stream follows a generic single stream DL video traffic model with the parameters illustrated in FIG. 7. A multi-stream model is described below. The CG DL multi-streams follow generic multi-streams DL traffic model with parameters illustrated in FIG. 8.

Resource configuration for multi-physical uplink/downlink shared channel (“PxSCH”) is described below. Multi-PxSCH supports time-domain resource allocation adaptation between the transmissions of multi-PxSCH where the time-domain allocation field in scheduling DCI reference an entry in a RRC configured table/list pdsch-TimeDomainAllocationListForMultiPDSCH-r17 or pusch-TimeDomainAllocationListForMultiPUSCH. In the tables/lists there is a field indicating number of multi-PxSCH which means by configuring the tables/lists with different number of multi-PxSCHs the scheduler is enabled to dynamically select number of PxSCHs in the multi-PxSCH.

Multi-physical downlink shared channel (“PDSCH”) is described below. If a UE is configured with pdsch-TimeDomainAllocationListForMultiPDSCH-r17 in which one or more rows include multiple start and length indicators (“SLIVs”) for PDSCH, the UE does not expect to be configured with higher layer parameter repetitionNumber in pdsch-TimeDomainAllocationListForMultiPDSCH-r17. If a UE is configured with pdsch-TimeDomainAllocationListForMultiPDSCH-r17 in which one or more rows include n multiple SLIVs for PDSCH on a DL bandwidth part (“BWP”) of a serving cell, the UE does not apply pdsch-AggregationFactor in PDSCH-config, if configured, to downlink control information (“DCI”) format 1_1 on the DL BWP of the serving cell. If a UE is configured with pdsch-TimeDomainAllocationListForMultiPDSCH-r17 in which one or more rows include multiple SLIVs for PDSCH on a DL BWP of a serving cell, when any two DL DCIs end in the same symbol and at least one of the DCIs schedules multiple PDSCHs, the UE does not expect that the scheduled PDSCH(s) by the two DCIs have overlapping spans, where the span associated with a DCI is defined from the beginning of the first scheduled PDSCH or up to the end of the last scheduled PDSCH.

Multi-physical uplink shared channel (“PUSCH”) is described below. If a UE is configured with higher layer parameter pusch-TimeDomainAllocationListForMultiPUSCH, the UE does not expect to be configured with pusch-AggregationFactor. If a UE is configured with pusch-TimeDomainAllocationListForMultiPUSCH-r17 in which one or more rows include multiple SLIVs for PUSCH on an uplink (“UL”) BWP of a serving cell, the UE does not apply pusch-AggregationFactor, if configured, to DCI format 0_1 on the UL BWP of the serving cell and the UE does not expect to be configured with numberOfRepetitions in pusch-TimeDomainAllocationListForMultiPUSCH-r17. If a UE is configured with pusch-TimeDomainAllocationListForMultiPUSCH-r17 in which one or more rows include multiple SLIVs for PUSCH on a UL BWP of a serving cell, when any two UL DCIs end in the same symbol and at least one of the DCIs scheduling multiple PUSCHs, the UE does not expect that the any scheduled multiple PUSCHs have overlapping spans, where the span associated with a DCI is defined from the beginning of the first scheduled PUSCH till the end of the last scheduled PUSCH.

### SUMMARY

According to one aspect of the present disclosure, a method operated by a communication device is provided. The method includes receiving a plurality of frequency adaptive multi-PxSCH configurations for the communication device and downlink control information, DCI from a network node, and communicating with the network node using parameters associated with a multi-PxSCH configuration of the plurality of frequency adaptive multi-PxSCH configurations based on the DC.

According to one or more embodiments of this aspect, the types of the parameters include at least one of: size and offset of a transmission block to be communicated by the communication device.

According to some further embodiments of this aspect, the offset is set with respect to any of: a region boundary, a reference PRB, and start/end location of a previous transmission block.

According to another aspect of the present disclosure, a communication device operative for performing the methods described in embodiments for the communication device in the disclosure is provided.

According to another aspect of the present disclosure, a method operated by a network node in a communications network is provided. The method includes transmitting a plurality of frequency adaptive multi-PxSCH configurations and DCI to a communication device, and then, communicating with the communication device using parameters associated with a multi-PxSCH configuration of the plurality of frequency adaptive multi-PxSCH configurations based on the DCI.

According to one or more embodiments of this aspect, the plurality of frequency adaptive PxSCH configurations is transmitted via a RRC message.

According to one or more embodiments of this aspect, to communicate with the communication device using parameters associated with a multi-PxSCH configuration is based on a format of the DCI.

According to yet another aspect of the present disclosure, a network node operative for performing the methods described in embodiments for the network node in this disclosure is provided.

Methodology for frequency adaption for multiple TBs is provided in this disclosure. The TB size and offset both for frequency domain can be set different for different TBs in a multi-slot/multi-PxSCH allocation. By means of defining parameters related to sizes, offsets for different TBs and the granularity of resources impacting the size and offset, resource allocation on frequency domain can switch between granularities and different locations to achieve flexibility.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5^{th} generation (“5G”) network;

FIGS. 2-3 are tables illustrating examples of parameters used for single stream augmented reality (“AR”)/virtual reality (“VR”) downlink (“DL”) streams;

FIGS. 4-5 are tables illustrating examples of parameters used for multi-stream AR/VR DL streams;

FIGS. 6-7 are tables illustrating examples of parameters used for single stream cloud gaming (“CG”) DL streams;

FIG. 8 is a table illustrating an example of parameters used for multi-stream CG DL streams;

FIG. 9 is a block diagram illustrating an example of a scenario in which a DL control information (“DCI”) allocates resources for 4 transmission blocks (“TBs”) of different sizes and offsets in accordance with some embodiments;

FIG. 10 is a graph illustrating an example of capacity gains with dynamic physical resource blocks (“PRBs”) for TBs multi-slot allocation is higher than same PRB allocation for multi-slot allocation in accordance with some embodiments;

FIG. 11 is a diagram illustrating an example of an active bandwidth part (“BWP”) divided into 3 regions with granularity size of 25 PRBs in accordance with some embodiments;

FIG. 12 is a diagram illustrating an example of interlacing of PRBs in a given region in accordance with some embodiments;

FIG. 13 is a table illustrating an example of a TB size allocation value in accordance with some embodiments;

FIG. 14 is a table illustrating an example of a pattern of TB sizes with multiple TBs in accordance with some embodiments;

FIG. 15 is a table illustrating an example of allowable TB values in accordance with some embodiments;

FIG. 16 is a table illustrating an example of a allowable offset values for TB location in frequency domain in accordance with some embodiments;

FIG. 17 is a table illustrating an example of a frequency domain resource allocation (“FDRA”) table with two new (alternate) configuration in accordance with some embodiments;

FIG. 18 is a graph illustrating an example of a FDRA bitmap size for different configurations in accordance with some embodiments;

FIG. 19 is a flow chart illustrating an example of operations performed by a communication device in accordance with some embodiments;

FIG. 20 is a flow chart illustrating an example of operations performed by a network node in accordance with some embodiments;

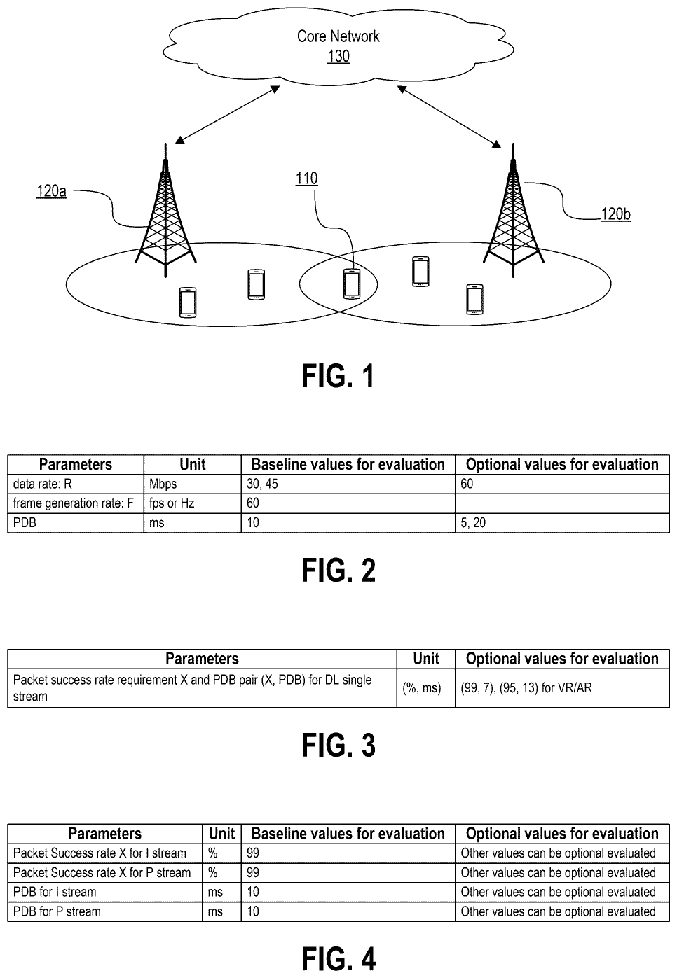

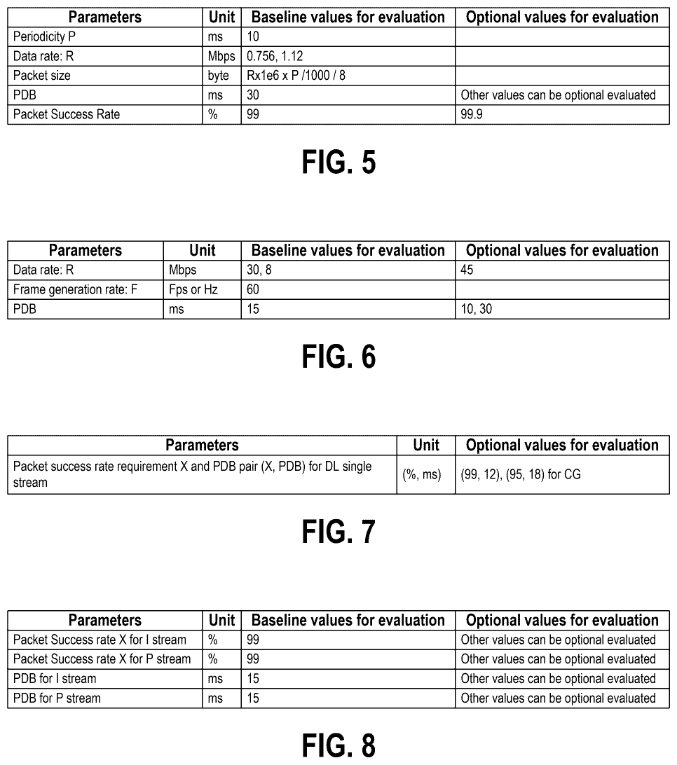

Figure QQ1 is a block diagram of a communication system in accordance with some embodiments;

Figure QQ2 is a block diagram of a user equipment in accordance with some embodiments;

Figure QQ3 is a block diagram of a network node in accordance with some embodiments;

Figure QQ4 is a block diagram of a host computer communicating with a user equipment in accordance with some embodiments;

Figure QQ5 is a block diagram of a virtualization environment in accordance with some embodiments; and

Figure QQ6 is a block diagram of a host computer communicating via a base station with a user equipment over a partially wireless connection in accordance with some embodiments in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

Various embodiments herein use multi-slot allocation terminology. In some examples, it can be termed as multi-transmission block (“TB”), multi-hybrid automatic repeat request (“HARQ”), multi-transmission, multi-physical downlink/uplink shared channel (“PxSCH”) or multi-physical downlink shared channel (“PDSCH”)/physical uplink shared channel (“PUSCH”) transmissions allocated by downlink control information (“DCI”)/radio resource control (“RRC”) based signaling (for new radio (“NR”) or NR unlicensed (“NR-U”)). The essence is that a scheduled resource allocation can span over multiple scheduling time units (e.g. N time units, N is an integer and N>1), where the time unit can be a slot (hence: multi-slot allocation), or the time unit can be a mini-slot (hence: multi-mini-slot allocation), or the time unit can be a set of N consecutive symbols. The scheduling need not to be purely slot-based. For example, a multi-slot uplink (“UL”)/downlink (“DL”) allocation over 1.5 slots can be such with sym 0 to sym 5 for TB1, sym 6 to sym 13 for TB2 and sym 0 to sym 6 in the next slot for TB3.

Embodiments herein can be applied to licensed, shared, NR-U. NR, time division duplex (“TDD”), and frequency division duplex (“FDD”) types of spectrum

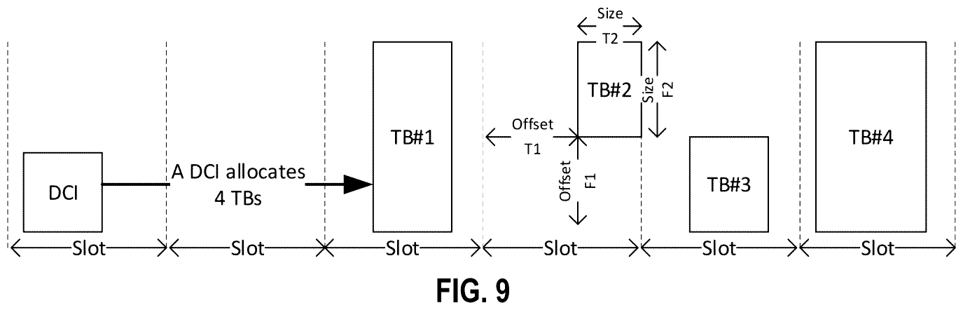

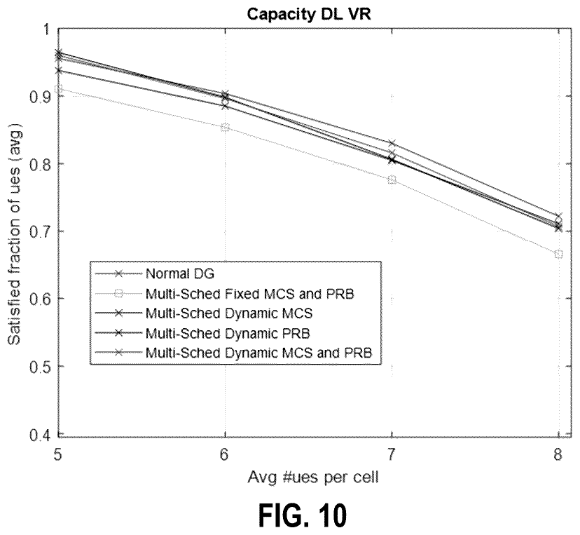

In some embodiments, for each TB, part of multi-slot/multi-PxSCH allocation, the network can configure the TB with varying characteristics pertaining to parameters related to size, offset, and granularity. FIG. 9 illustrates an example in which different TBs are allocated with different sizes and staring locations.

In additional or alternative embodiments, among the TBs from multi-slot allocation, the size of each TB can be different in Frequency domain (e.g., number of PRBs in a TB).

In additional or alternative embodiments, the granularity for which size of TB in frequency domain is defined can be in order of: Unit PRB; and group of PRBs.

In additional or alternative embodiments, the resource in frequency domain, such as carrier or bandwidth part (“BWP”) can be divided into regions/groups, where each TB can be configured for the particular indicated region.

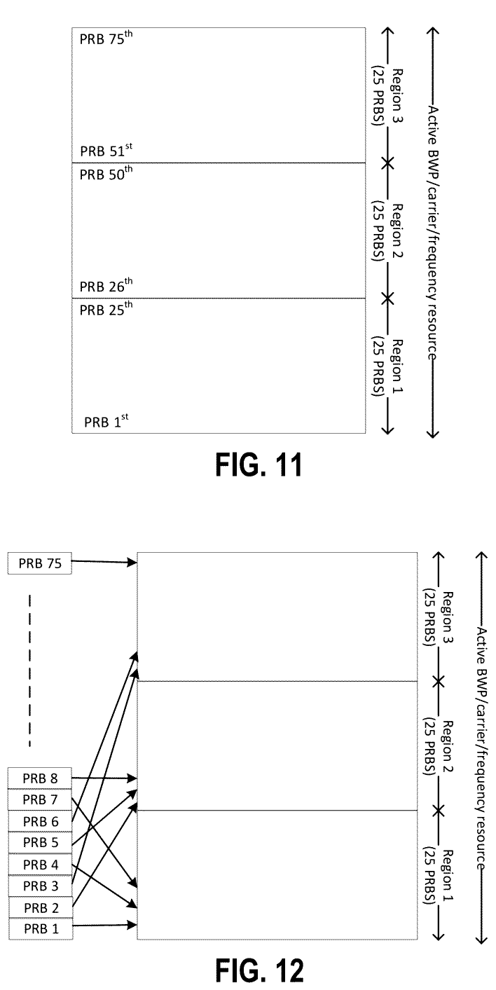

In some examples, in which a BWP includes 75 PRBs (1^{st} to 75^{th} PRB). The network can divide the spectrum/BWP/carrier into 3 regions each of 25 PRBs. FIG. 11 illustrates an example including region 1 with 1^{st} to 25^{th} PRB, region 2 with 26^{th} PRB to 50^{th} PRB, and region 3 with 51^{st} to 75^{th} PRB. Based on the example described in FIG. 9, TB #1 (resource for 1st transmission) is allocated to region 1 and 2 (from 1^{st} to 50^{th} PRB), TB #2 is allocated to region 2, TB #3 is allocated to region 3, and TB #4allocated to region 1 and 2. In another example, the region can be bitmap of PRBs, as illustrated in FIG. 12. In this example, Region 1 consists of PRBs {1,4,7 . . . ,73}, Region 2 consists of PRBs {2,5,8, . . . ,74}, and Region 2 consists of PRBs {3,6,9, . . . ,75}.

As discussed in the above example, in various embodiments the regions can be divided into multiple ways. In some examples, region of continuous PRBs (as illustrated in FIG. 11) can be indicate by following ways: (1) Bit map of PRBs for a given region, say the network provides configuration Region by indicating Bitmap of PRB: {1,2, . . . 25}; and (2) Using start PRB, and/or end PRB, and/or number of

PRBs in the region. For example, a network can indicate two parameters for a region: starting PRB, and number of PRBs, for example, for Region 1, it will be 1,25, i.e., PRB #1 and 25 PRBs (means PRB 1 to PRB 25).

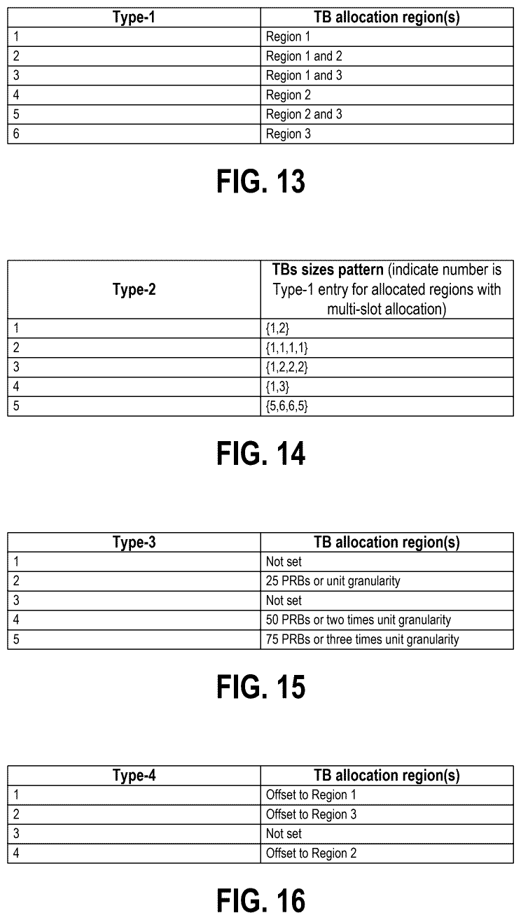

In additional or alternative examples, a region with interlacing of PRBs as illustrated in FIG. 13 can be indicates via (1) Bitmap of PRBs for a region; and (2) Parameters which can indicate starting PRB, and periodicity/gap, and the number of PRBs. Say, for region 1, starting PRB is 1, the gap is 3, and the number of PRBs is 25, and this will give PRBs: 1, 4 . . . , 73.

In additional or alternative embodiments, a network defines the granularity of a region. In some examples, it is 25 PRBs (e.g., minimal size of region is 25 PRBs for any TB allocation).

In additional or alternative embodiments, TB can be allocated over one or more regions, (e.g., a TB resource can be provided over spanning region1 and 2).

In additional or alternative embodiments, a network can define patterns in RRC configuration for allocation if TB resources in the frequency domain. Network can send DCI selecting one of the patterns provided in RRC configuration which indicates the TBs' allocation. For example, where spectrum is divided into 3 regions, in RRC configuration network defines following pattern.

FIG. 13 is a RRC table indicating the allowable allocation size for an TB. FIG. 14 is a RRC Table indicating the allowable patterns. If any of Type 2 column indicates {x,z,p,q} under TB pattern column, then for 1st TB allocation, size is mapped to size indicated by x-th entry in the table in FIG. 13 under Type-1 column, similarly z indicates TB size for 2^{nd} TB, so on.

In additional or alternative embodiments, the network can indicate TB allocation size in the DCI. In some examples, the network can indicate Type-2 entry in the DCI indicating pattern. For example, network can indicate Type-2 entry in a relevant bitfield. In additional or alternative examples, 2 can indicate 4 TBs resources are allocated in Region 1 and 4 can indicate 2 TBs resources are allocated, where a 1^{st} TB allocated in Region 2 and a 2^{nd} TB resource allocated in 3 respectively

In additional or alternative embodiments, a network can indicate Type-1 entry for each TB in the DCI. For example, if in a relevant DCI bitfield indicates {1,2,2,2,2,2,2,2}, it means 8 TBs are allocated, where 1^{st} TB is in Region 1 and remaining are spanned over Region 1 and 2.

In additional or alternative embodiments, if a network indicates allocation of M1 TBs, but the pattern indicates for M2 TBs resource allocation, where M2<M1, then the pattern will repeat itself, or the modulo of pattern will apply to acquire the allocation regions of the allocated TBs. For example, a network allocates 5 TBs, but the pattern indicates Type-2 entry number 4 (e.g., pattern {1,3}), then it means for 5 TBs, the allocation pattern will repeat covering until the 5^{th} TB e.g., ({1,3,1,3,1}).

In additional or alternative embodiments, among the TBs from multi-slot allocation, the location of each TB (staring or ending) can be different in Frequency domain. For example, for allocation with contiguous PRBs for TBs (based on FIG. 11), 1^{st} TB begins in at PRB X, then next/2^{nd} TB begins at PRB Y, where X≠Y.

In additional or alternative embodiments, in order to define a set location of TB, network can define offset (in frequency domain), which can be set in following manner: (1) With respect to region boundary (see FIGS. 11-12); (2) With respect to reference PRB, say PRB X, (e.g., PRB1); and (3) With respect to start/end location of pervious TB.

In additional or alternative embodiments, the frequency-based offset (e.g., offset F1) can be defined of an order of: (1) Unit PRB; and (2) Group of PRBs. For example, if a spectrum of 75 PRBs divided into 3 regions with granularity of 25 PRBs, one can define 3 types of offsets towards each region, i.e., offset 0, 1, and 2 point to region 1 (starting with 0^{th} PRB), region 2 (starting with 26^{th} PRB), and region 3 (starting with 51^{st} PRB) respectively. In additional or alternative embodiments, a network can define granularity of offset.

In additional or alternative embodiments, a pattern can be determined based on TB size pattern and the applied offset pattern. In some examples, two parameters can be defined (e.g., tables can be RRC configured). FIG. 15 is a RRC table providing allowable TB size. FIG. 16 is a RRC table providing allowable offset values in frequency domain. In some examples, if network wants to indicate an allocation with 4 TBs, such that first two TBs have 25 PRBs size and last two TBs have 50 PRBs size, where: 1^{st} TB starts in Region 2; 2^{nd} TB starts in Region 1; 3^{rd} TB starts in Region 1 (due to its size of 50 PRBS, it will be allocated in both Region 1 and 2); and 4^{th} TB starts in Region 3 (due to its size of 50 PRBS, it will be allocated in both Region 3 and 1 (due to modulo, as there is no Region 4, then it will be back to Region 1)). Then a pattern can be indicated as following: TB size pattern using FIG. 15 values: {2,2,4,4}; and Offset pattern using FIG. 16 values: {4,1,1,2}.

In additional or alternative embodiments, the multi-slot allocation can be a dynamically allocated grant or assignment and semipersistent-based or periodic allocation in DL (SPS) or UL (CG). In this example, in each period of an SPS or CG, a multi-slot allocation is per-configured.

In additional or alternative embodiments, the multi-slot allocation can be allocated using DCI, activation DCI, or RRC based signaling. In some examples, in FIG. 9 instead of DCI, the allocation signaling can be activation DCI (for DL SPS or UL CG type 2) or RRC based activation signaling for UL CG type 1.

Embodiments on Signaling of (frequency) adaptive multi-PxSCH are described below.

In some embodiments, the UE is configured with “frequency-adaptive-multi-PxSCH” by RRC. There may be one such parameter for both PDSCH and PUSCH, or frequency-adaptation of multi-PxSCH can be configured independently for PDSCH and PUSCH (i.e., two parameters, one for PDSCH and one for PUSCH). If “frequency-adaptive-multi-PxSCH” is configured, then the UE assumes that the DCI that schedules the multi-PxSCH has N multiples of the “Frequency domain resource assignment” field in the DCI. The number N is preferable determined by UE as the largest value of the number of fields indicating number of multi-PxSCH in pdsch-TimeDomainAllocationListForMultiPDSCH-r17 (for PDSCH) or pusch-TimeDomainAllocationListForMultiPUSCH (for PUSCH). It is, however, possible that N is explicitly configured parameter. For example, the fields in Rel-17 DCI format 1_1 (or DCI format 0_X/1_X) are structured as: Identifier for DCI formats—1 bits; Carrier indicator—0 or 3 bits; Bandwidth part indicator—0, 1 or 2 bits; and Frequency domain resource assignment-number of bits determined by the following, where [symbol] is the size of the active DL bandwidth part.

While in Rel-X if “frequency-adaptive-multi-PxSCH” is configured and N is determined by UE as N=3 the UE assumes the DCI format 1_1 to be formatted as: Identifier for DCI formats—1 bits; Carrier indicator—0 or 3 bits; Bandwidth part indicator—0, 1 or 2 bits; Frequency domain resource assignment #1—number of bits determined by the following, where [symbol] is the size of the active DL bandwidth part; Frequency domain resource assignment #2—number of bits determined by the following, where [symbol] is the size of the active DL bandwidth part; and Frequency domain resource assignment #3—number of bits determined by the following, where [symbol] is the size of the active DL bandwidth part.

In some examples, the network can configure N in RRC depending on UE's traffic characteristics. Say, a UE is needed allocation usually between 1-4 TBs. It means, network can configure N=4, i.e., with a multi-slot allocation, UE can be allocated with maximal 4 TBs (possibly with varying sizes in frequency domain and/or time domain). Note, if a UE is allocated, say 3 TBs allocation, the bitfield/length of some field is still based on N=4 or function of N =4, however the indicated codeword would be 3 (3 TB allocation) because UE is configured for maximum N=4, but the codeword or the desired allocation can be {1,2,3,4}.

In additional or alternative examples, the number M of transmissions in the multi-PxSCH indicated by the time domain resource allocation field in scheduling DCI is smaller than N, then UE assumes the frequency domain resource assignment field #(M+1) to #N to be un-used. In additional or alternative examples, the UE may assume all the frequency domain resource assignment field #(M+1) to #N to be all-zero fields.

Embodiments associated with a size of FDRA fields are described below. In some embodiments, since the size of all FDRA fields can become large due to multiple TBs potentially being transmitted, it is beneficial to make each FDRA #x bitfield smaller. For this purpose a coarser frequency allocation granularity can be introduced. Another motivation for coarser granularity is specifics of XR traffic, where video flow is carried by large packets which require big chunks of BWP for every transmission in radio. Currently for allocation type 0 (bitmap), the granularity is defined in a table where two configuration options are available (e.g., Configuration 1 and Configuration 2). In order to make the granularity coarse, one can introduce new configuration (e.g., Configuration 3 where larger values P are defined). Moreover, values P in the table can be controlled by RRC parameters.

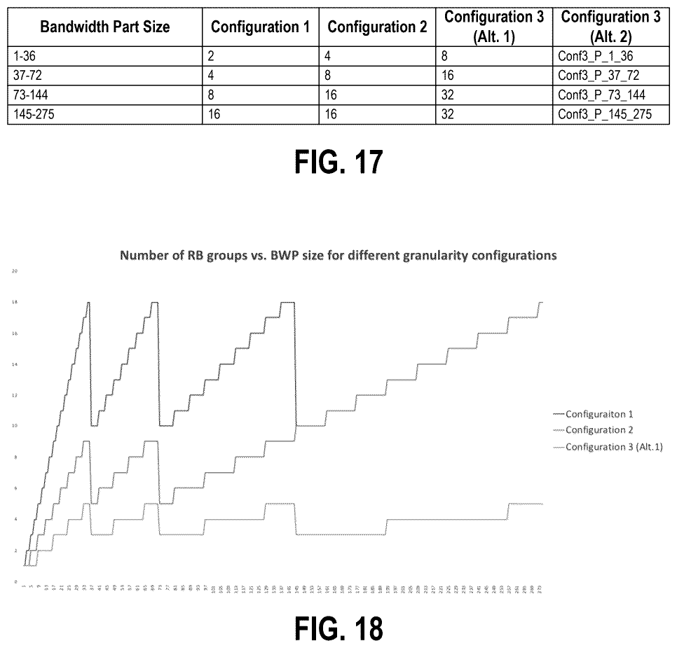

FIG. 17 illustrates an example of a table of FDRA fields including new configurations 3 and 4. An illustration of bitmap size which is equal to number of RB groups for different configurations is shown in FIG. 18. In case of configuration 1 and Configuration 2, the size of the FDRA bitmap can be up to 18 bits, which is too much if it will be repeated N times in DCI. In case of Configuration 3 (Alt. 1), the bitmap size can be at maximum 5 bits.

Embodiments on switching between coarse FDRA and regular FDRA are described below. In some embodiments, since XR device transmits and receives different kind of traffic, it can be beneficial to use different FDRA approach to different traffic types. For example, for video traffic, as said, coarse frequency granularity can be used, while for pose or other data traffic (URLLC), allocation in frequency will be small due to small TBS. This is also valid for the leftover of large video traffic: for example 95% of large video packet is sent by using multi-slot full BW transmission, while for the rest 5% of application unit, there is a need to do very precise allocation to minimize padding bits.

In order to switch between coarse multi-PxSCH and possibly fine FDRA granularity, several operations can be performed. In some examples, the operations include using different DCI formats. For example, for fine granularity a compact DCI 0_2 or 1_2 can be used, while DCI 0_1 and 1_1 are used for coarse granularity. In this case, different RRC parameters are used to control FDRA type. In additional or alternative examples, the operations include using new

radio network temporary identifier (“RNTI”) is assigned to UE to indicate that coarse/different granularity is used (e.g., FDRA-C-RNTI). For example, a UE can be configured to use configuration 3 (alt-1) in FIG. 17. If a UE is scheduled with scheduling DCI (multi-slot or single slot based) scrambled with, say cell-RNTI (“C-RNTI”), the granularity of resource allocation in frequency based on (Alt-1) configuration in FIG. 17 for given BWP size. This can be utilized for default operation of big or large packets. Now, a pose/URLLC packet arrives, it does not granularity of big PRBs grouping, for instance configuration 1 is good due to small TBS, then to differentiate from default allocation based on configuration 3, its allocation can be scrambled with FDRA-C-RNTI. The example can be summarized as: DCI scrambled with C-RNTI (Allocation based on configuration 3), Alt-1 and DCI scrambled with FDRA-C-RNTI (Allocation based on configuration 1).

In an additional or alternative examples, more RNTIs can be defined: DCI scrambled with C-RANTI (Allocation based on configuration 1); DCI scrambled with FDRA-C-RNTI (Allocation based on configuration 3, Alt-2); and DCI scrambled with FDRA1-C-RNTI (Allocation based on configuration 2).

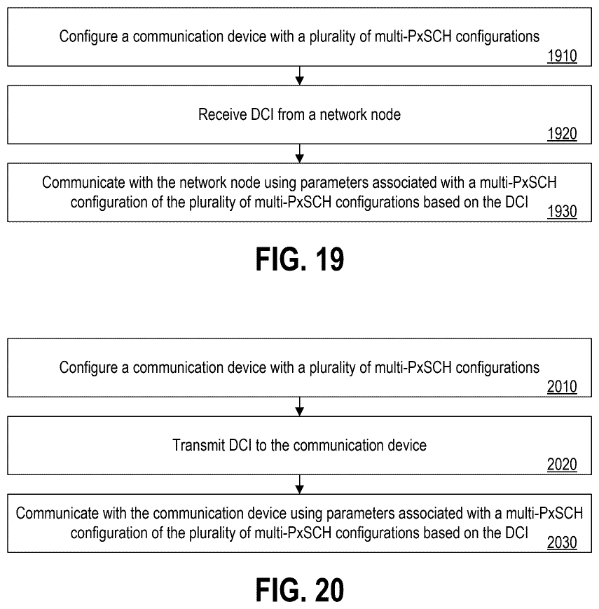

In the description that follows, while the communication device may be any of wireless device QQ112A-B, wireless devices UE QQ112C-D, UE QQ200, virtualization hardware QQ504, virtual machines QQ508A, QQ508B, or UE QQ606, the UE QQ200 (also referred to herein as communication device QQ200) shall be used to describe the functionality of the operations of the communication device. Operations of the communication device QQ200 (implemented using the structure of the block diagram of FIG. QQ2) will now be discussed with reference to the flow chart of FIG. 19 according to some embodiments of inventive concepts. For example, modules may be stored in memory QQ210 of FIG. QQ2, and these modules may provide instructions so that when the instructions of a module are executed by respective communication device processing circuitry QQ202, processing circuitry QQ202 performs respective operations of the flow chart.

FIG. 19 illustrates operations performed by a communication device. In some embodiments, the communication device includes an extended reality, XR, device.

At block 1910, processing circuitry QQ202 configures a communication device with a plurality of multi-PxSCH configurations. In some embodiments, the plurality of multi-PxSCH includes a plurality of frequency adaptive multi-PxSCH. In additional or alternative embodiments, configuring the communication device includes receiving a radio resource control, RRC, message including an indication of the multi-PxSCH configurations.

In additional or alternative embodiments, configuring the communication device with the plurality of multi-PxSCH configurations includes determining a frequency domain resource allocation, FDRA, bitmap.

At block 1920, processing circuitry QQ202 receives, via communication interface QQ212, DCI from a network node. In some embodiments, receiving the DCI includes receiving the DCI scrambled with a cell-radio network temporary identifier, C-RNTI, indicating a configuration of the FDRA bitmap.

At block 1930, processing circuitry QQ202 communicates with the network node using parameters associated with a multi-PxSCH configuration of the plurality of multi-PxSCH configurations based on the DCI. In some embodiments, the parameters include at least one of: size; offset; and granularity.

In additional or alternative embodiments, communicating with the network node using the parameters includes: transmitting a first transmission block, TB, having a first parameter based on the DCI; and transmitting a second transmission block, TB, having a second parameter based on the DCI, the second parameter being different than the first parameter.

In additional or alternative embodiments, communicating with the network node using the parameters includes: receiving a first transmission block, TB, having a first parameter based on the DCI; and receiving a second transmission block, TB, having a second parameter based on the DCI, the second parameter being different than the first parameter.

In additional or alternative embodiments, communicating with the network node using the parameters associated with the multi-PxSCH configuration of the plurality of multi-PxSCH configurations based on the DCI includes communicating with the network node using the parameters associated with the multi-PxSCH configuration of the plurality of multi-PxSCH configurations based on a format of the DCI.

Various operations illustrated in FIG. 19 may be optional in respect to some embodiments.

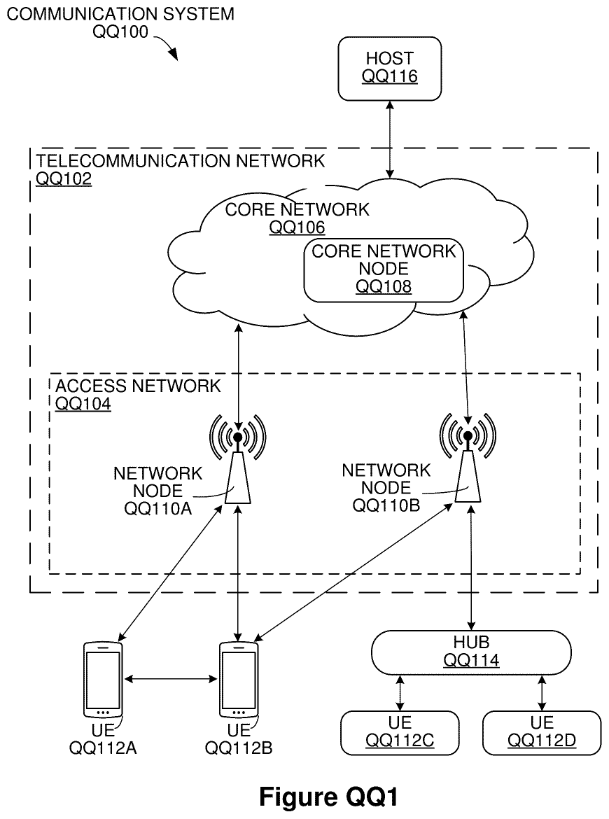

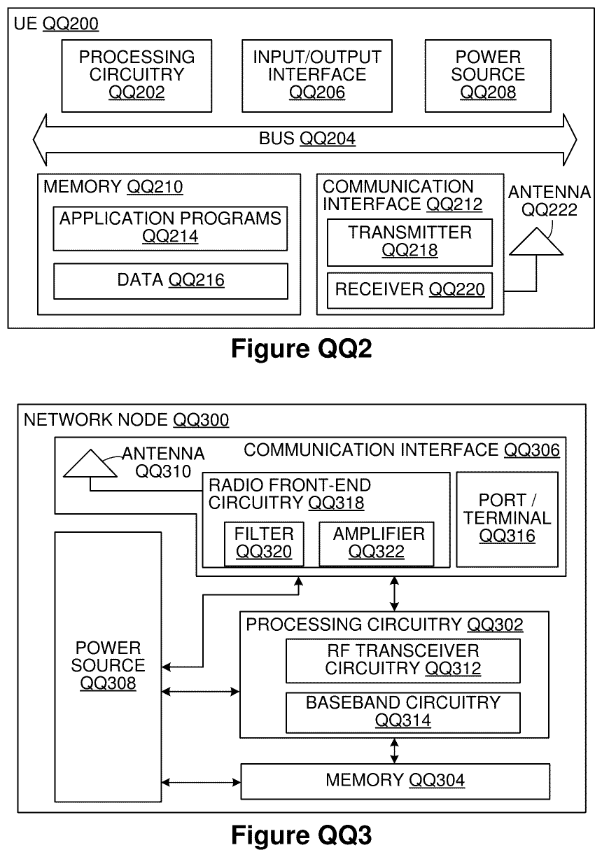

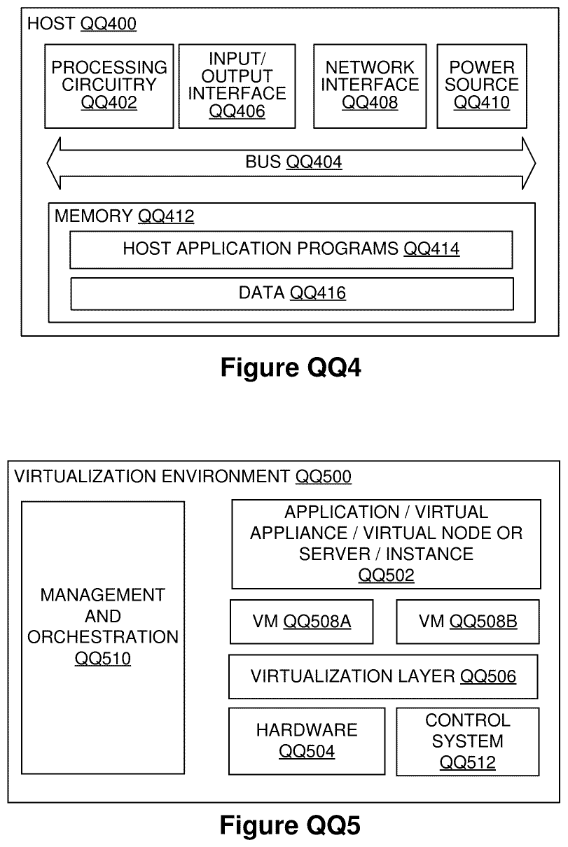

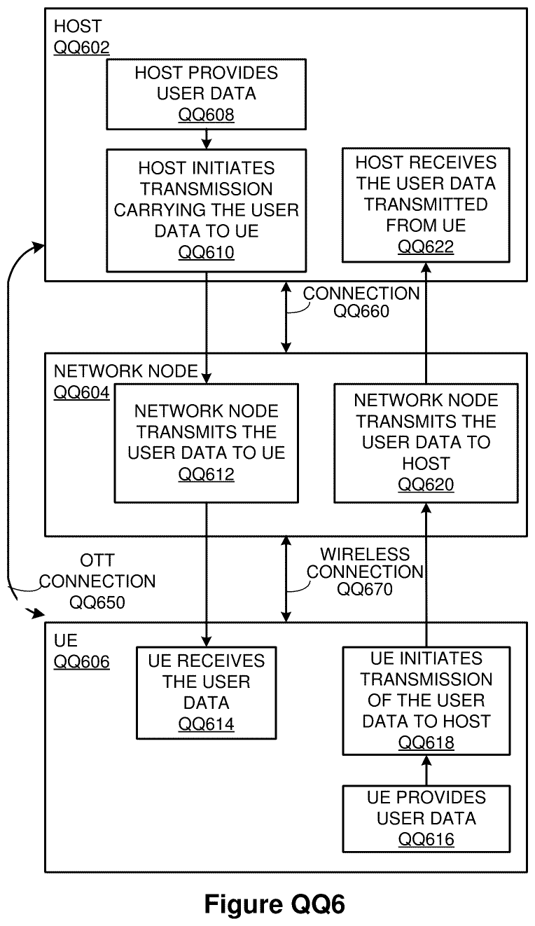

In the description that follows, while the network node may be any of network nodes QQ110A-B, core network node QQ108, HUB QQ114, network node QQ300, virtualization hardware QQ504, virtual machines QQ508A, QQ508B, or network node QQ604, the network node QQ300 shall be used to describe the functionality of the operations of the communication device. Operations of the network node QQ300 (implemented using the structure of the block diagram of FIG. QQ3) will now be discussed with reference to the flow chart of FIG. 20 according to some embodiments of inventive concepts. For example, modules may be stored in memory QQ304 of FIG. QQ3, and these modules may provide instructions so that when the instructions of a module are executed by respective network node processing circuitry QQ302, processing circuitry QQ302 performs respective operations of the flow chart.

FIG. 20 illustrates operations performed by a network node. In some embodiments, the communication device includes an extended reality. XR, device.

At block 2010, processing circuitry QQ302 configures a communication device with a plurality of multi-PxSCH configurations. In some embodiments, the plurality of multi-PxSCH includes a plurality of frequency adaptive multi-PxSCH. In additional or alternative embodiments, configuring the communication device includes transmitting a radio resource control, RRC, message including an indication of the multi-PxSCH configurations.

In additional or alternative embodiments, configuring the communication device with the plurality of multi-PxSCH configurations includes determining a frequency domain resource allocation, FDRA, bitmap.

At block 2020, processing circuitry QQ302 transmits, via communication interface QQ306, DCI to the communication device. In some embodiments, transmitting the DCI includes transmitting the DCI scrambled with a cell-radio network temporary identifier, C-RNTI, indicating a configuration of the FDRA bitmap.

At block 2030, processing circuitry QQ302 communicates with the communication device using parameters associated with a multi-PxSCH configuration of the plurality of multi-PxSCH configurations based on the DCI. In some embodiments, the parameters include at least one of: size; offset; and granularity.

In additional or alternative embodiments, communicating with the communication device using the parameters includes: transmitting a first transmission block, TB, having a first parameter based on the DCI; and transmitting a second transmission block, TB, having a second parameter based on the DCI, the second parameter being different than the first parameter.

In additional or alternative embodiments, communicating with the communication device using the parameters includes: receiving a first transmission block, TB, having a first parameter based on the DCI; and receiving a second transmission block, TB, having a second parameter based on the DCI, the second parameter being different than the first parameter.

In additional or alternative embodiments, communicating with the communication device using the parameters associated with the multi-PxSCH configuration of the plurality of multi-PxSCH configurations based on the DCI includes communicating with the communication device using the parameters associated with the multi-PxSCH configuration of the plurality of multi-PxSCH configurations based on a format of the DCI.

Various operations illustrated in FIG. 20 may be optional in respect to some embodiments.

Figure QQ1 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3^{rd} Generation Partnership Project (3GPP) access node or non-3GPP access point. Moreover, as will be appreciated by those of skill in the art, the network nodes QQ110 are not necessarily limited to an implementation in which a radio portion and a baseband portion are supplied and integrated by a single vendor. Thus, it will be understood that the network nodes QQ110 may include disaggregated implementations or portions thereof. For example, in some embodiments, the telecommunication network QQ102 includes one or more Open-RAN (ORAN) network nodes. An ORAN network node is a node in the telecommunication network QQ102 that supports an ORAN specification (e.g., a specification published by the

O-RAN Alliance, or any similar organization) and may operate alone or together with other nodes to implement one or more functionalities of any node in the telecommunication network QQ102, including one or more network nodes QQ110 and/or core network nodes QQ108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time RAN control application (e.g., xApp) or a non-real time RAN automation application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Intents and content-aware notifications described herein may be communicated from a 3GPP network node or an ORAN network node over 3GPP-defined interfaces (e.g., N2, N3) and/or ORAN Alliance-defined interfaces (e.g., A1, O1). Moreover, an ORAN network node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance. The network nodes QQ110 facilitate direct or indirect connection of user equipment (UE), such as by connecting wireless devices QQ112a, QQ112b, QQ112c, and QQ112d (one or more of which may be generally referred to as UEs QQ112) to the core network QQ106 over one or more wireless connections. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of Figure QQ1 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

Figure QQ2 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in Figure QQ2. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in Figure QQ2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

Figure QQ3 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs). NR NodeBs (gNBs)), O-RAN nodes, or components of an O-RAN node (e.g., intelligent controller, O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in Figure QQ3 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

Figure QQ4 is a block diagram of a host QQ400, which may be an embodiment of the host QQ116 of Figure QQ1, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

Figure QQ5 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment QQ500 includes components defined by the O-RAN Alliance, such as an O-Cloud environment orchestrated by a Service Management and Orchestration Framework via an O-2 interface.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

Figure QQ6 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of Figure QQ1 and/or UE QQ200 of Figure QQ2), network node (such as network node QQ110a of Figure QQ1 and/or network node QQ300 of Figure QQ3), and host (such as host QQ116 of Figure QQ1 and/or host QQ400 of Figure QQ4) discussed in the preceding paragraphs will now be described with reference to Figure QQ6.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of Figure QQ1) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602. In some examples, the UE QQ606 executes a client application which

provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606.

Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may allow PDCCH resources to be saved and used in case of multi-slot allocation for shared channel allocation (allocating more TBs), and therefore, in actual, multi-slot allocation with have higher capacity gains than normal DG with single slot allocation.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Embodiments

1. A method of operating a communication device in a communications network, the method comprising:
   configuring (1910) the communication device with a plurality of multi-physical uplink/downlink shared channel, PxSCH, configurations;
   receiving (1920) downlink control information, DCI, from a network node; and
   communicating (1930) with the network node using parameters associated with a multi-PxSCH configuration of the plurality of multi-PxSCH configurations based on the DCI.
2. The method of Embodiment 1, wherein the plurality of multi-PxSCH comprises a plurality of frequency adaptive multi-PxSCH.
3. The method of any of Embodiments 1-2, wherein configuring the communication device comprises receiving a radio resource control, RRC, message including an indication of the multi-PxSCH configurations.
4. The method of any of Embodiments 1-3, wherein the parameters comprise at least one of: size; offset; and granularity.
5. The method of any of Embodiments 1-4, wherein communicating with the network node using the parameters comprises:
   transmitting a first transmission block, TB, having a first parameter based on the DCI; and
   transmitting a second transmission block, TB, having a second parameter based on the DCI, the second parameter being different than the first parameter.
6. The method of any of Embodiments 1-5, wherein communicating with the network node using the parameters comprises:
   receiving a first transmission block, TB, having a first parameter based on the DCI; and
   receiving a second transmission block, TB, having a second parameter based on the DCI, the second parameter being different than the first parameter.
7. The method of any of Embodiments 1-6, wherein communicating with the network node using the parameters associated with the multi-PxSCH configuration of the plurality of multi-PxSCH configurations based on the DCI comprises communicating with the network node using the parameters associated with the multi-PxSCH configuration of the plurality of multi-PxSCH configurations based on a format of the DCI.
8. The method of any of Embodiments 1-7, wherein configuring the communication device with the plurality of multi-PxSCH configurations comprises determining a frequency domain resource allocation, FDRA, bitmap.
9. The method of Embodiment 8, wherein receiving the DCI comprises receiving the DCI scrambled with a cell-radio network temporary identifier, C-RNTI, indicating a configuration of the FDRA bitmap.
10. The method of any of Embodiments 1-9, wherein the communication device comprises an extended reality, XR, device.
11. A method of operating a network node in a communications network, the method comprising:
   configuring (2010) a communication device with a plurality of multi-physical uplink/downlink shared channel, PxSCH, configurations;
   transmitting (2020) downlink control information, DCI, to the communication device; and
   communicating (2030) with the communication device using parameters associated with a multi-PxSCH configuration of the plurality of multi-PxSCH configurations based on the DCI.
12. The method of Embodiment 11, wherein the plurality of multi-PxSCH comprises a plurality of frequency adaptive multi-PxSCH.
13. The method of any of Embodiments 11-12, wherein configuring the communication device comprises transmitting a radio resource control, RRC, message including an indication of the multi-PxSCH configurations.
14. The method of any of Embodiments 11-13, wherein the parameters comprise at least one of: size; offset; and granularity.
15. The method of any of Embodiments 11-14, wherein communicating with the communication device using the parameters comprises:
   transmitting a first transmission block, TB, having a first parameter based on the DCI; and
   transmitting a second transmission block, TB, having a second parameter based on the DCI, the second parameter being different than the first parameter.
16. The method of any of Embodiments 11-15, wherein communicating with the communication device using the parameters comprises:
   receiving a first transmission block, TB, having a first parameter based on the DCI; and
   receiving a second transmission block, TB, having a second parameter based on the DCI, the second parameter being different than the first parameter.
17. The method of any of Embodiments 11-16, wherein communicating with the communication device using the parameters associated with the multi-PxSCH configuration of the plurality of multi-PxSCH configurations based on the DCI comprises communicating with the communication device using the parameters associated with the multi-PxSCH configuration of the plurality of multi-PxSCH configurations based on a format of the DCI.
18. The method of any of Embodiments 11-17, wherein configuring the communication device with the plurality of multi-PxSCH configurations comprises determining a frequency domain resource allocation, FDRA, bitmap.
19. The method of Embodiment 18, wherein transmitting the DCI comprises transmitting the DCI scrambled with a cell-radio network temporary identifier, C-RNTI, indicating a configuration of the FDRA bitmap.
20. The method of any of Embodiments 11-19, wherein the communication device comprises an extended reality, XR, device.
21. A communication device (QQ200) operating in a communications network, the communication device comprising:
   processing circuitry (QQ202); and
   memory (QQ210) coupled to the processing circuitry and having instructions stored therein that are executable by the processing circuitry to cause the communication device to perform operations comprising any of the operations of Embodiments 1-10.
22. A computer program comprising program code to be executed by processing circuitry (QQ202) of a communication device (QQ200) operating in a communications network, whereby execution of the program code causes the communication device to perform operations comprising any operations of Embodiments 1-10.
23. A computer program product comprising a non-transitory storage medium (QQ210) including program code to be executed by processing circuitry (QQ202) of a communication device (QQ200) operating in a communications network, whereby execution of the program code causes the communication device to perform operations comprising any operations of Embodiments 1-10.
24. A non-transitory computer-readable medium having instructions stored therein that are executable by processing circuitry (QQ202) of a communication device (QQ200) operating in a communications network to cause the communication device to perform operations comprising any of the operations of Embodiments 1-10
25. A network node (QQ300) operating in a communications network, the network node comprising:
   processing circuitry (QQ302); and
   memory (QQ304) coupled to the processing circuitry and having instructions stored therein that are executable by the processing circuitry to cause the network node to perform operations comprising any of the operations of Embodiments 11-20.
26. A computer program comprising program code to be executed by processing circuitry (QQ302) of a network node (QQ300) operating in a communications network, whereby execution of the program code causes the network node to perform operations comprising any operations of Embodiments 11-20.
27. A computer program product comprising a non-transitory storage medium (QQ304) including program code to be executed by processing circuitry (QQ302) of a network node (QQ300) operating in a communications network, whereby execution of the program code causes the network node to perform operations comprising any operations of Embodiments 11-20.
28. A non-transitory computer-readable medium having instructions stored therein that are executable by processing circuitry (QQ302) of a network node (QQ300) operating in a communications network to cause the network node to perform operations comprising any of the operations of Embodiments 11-20.

### Abbreviations

At least some of the following abbreviations may be used in this disclosure. If there is an inconsistency between abbreviations, preference should be given to how it is used above. If listed multiple times below, the first listing should be preferred over any subsequent listing(s).
1× RTT CDMA2000 1× Radio Transmission Technology
3GPP 3rd Generation Partnership Project
5G 5th Generation
6G 6th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/NoCPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
USIM Universal Subscriber Identity Module
UTDOA Uplink Time Difference of Arrival
WCDMA Wide CDMA
WLAN Wide Local Area Network

1. A method of operating a communication device in a communications network, the method comprising:
receiving a plurality of frequency adaptive multi-physical uplink/downlink shared channel, PxSCH, configurations for the communication device;
receiving downlink control information, DCI, from a network node; and
communicating with the network node using parameters associated with a multi-PxSCH configuration of the plurality of frequency adaptive multi-PxSCH configurations based on the DCI.

2. The method of claim 1, wherein the plurality of frequency adaptive multi-PxSCH configurations is included in a radio resource control, RRC, message, and the RRC message further comprises an indication of the plurality of multi-PxSCH configurations.

3. The method of claim 1, wherein types of the parameters comprise at least one of: size and offset of a transmission block to be communicated by the communication device.

4. The method of claim 3, wherein types of the parameters further comprise granularity in frequency domain of the transmission block.

5. The method of claim 3, wherein the offset is set with respect to any of: a region boundary, a reference PRB, and start/end location of a previous transmission block.

6. The method of claim 1, wherein communicating with the network node using the parameters comprises:
transmitting and/or receiving a first transmission block, TB, having a first parameter based on the DCI; and
transmitting and/or receiving a second transmission block, TB, having a second parameter based on the DCI, the second parameter being different than the first parameter.

7. The method of claim 1, wherein communicating with the network node using the parameters associated with the multi-PxSCH configuration based on the DCI comprises communicating with the network node using the parameters associated with the multi-PxSCH configuration of the plurality of multi-PxSCH configurations based on a format of the DCI.

8. The method of claim 1, wherein the plurality of frequency adaptive multi-PxSCH configurations is indicated by a frequency domain resource allocation, FDRA, bitmap.

9. The method of claim 8, wherein receiving the DCI comprises receiving the DCI scrambled with a cell-radio network temporary identifier, C-RNTI, indicating a configuration of the FDRA bitmap.

10. The method of claim 1, wherein the communication device comprises an extended reality, XR, device.

11. A method of operating a network node in a communications network, the method comprising:
transmitting a plurality of frequency adaptive multi-physical uplink/downlink shared channel, PxSCH, configurations to a communication device;
transmitting downlink control information, DCI, to the communication device; and
communicating with the communication device using parameters associated with a multi-PxSCH configuration of the plurality of frequency adaptive multi-PxSCH configurations based on the DCI.

12. The method of claim 11, wherein transmitting a plurality of frequency adaptive PxSCH configurations to the communication device comprises transmitting a radio resource control, RRC, message and the RRC message further comprises an indication of the plurality of multi-PxSCH configurations.

13. The method of claim 11, wherein the parameters comprise at least one of: size; offset; and granularity; wherein the offset is set with respect to any of: a region boundary, a reference PRB, and start/end location of a previous transmission block.

14. A communication device operating in a communications network, the communication device comprising:
processing circuitry; and
memory coupled to the processing circuitry and having instructions stored therein that are executable by the processing circuitry to cause the communication device to:
receive a plurality of frequency adaptive multi-physical uplink/downlink shared channel, PxSCH, configurations for the communication device;
receive DCI from a network node; and
communicate with the network node using parameters associated with a multi-PxSCH configuration of the plurality of frequency adaptive multi-PxSCH configurations based on the DCI.

15. (canceled)

16. The method of claim 11, wherein communicating with the communication device comprises:
receiving and/or transmitting a first transmission block, TB, having a first parameter based on the DCI; and
receiving and/or transmitting a second transmission block, TB, having a second parameter based on the DCI, the second parameter being different than the first parameter.

17. The method of claim 11, wherein transmitting the DCI comprises transmitting the DCI scrambled with a cell-radio network temporary identifier, C-RNTI, indicating a configuration of the FDRA bitmap.

18. The communication device of claim 14, wherein the plurality of frequency adaptive multi-PxSCH configurations is included in an RRC message, and the RRC message further comprises an indication of the plurality of multi-PxSCH configurations.

19. The communication device of claim 14, wherein types of the parameters comprise at least one of: size and offset of a transmission block to be communicated by the communication device.

20. The communication device of claim 19, wherein the offset is set with respect to any of a region boundary, a reference PRB, and start/end location of a previous transmission block.

21. The communication device of claim 14, wherein the processing circuitry causes the communication device to communicate with the network node using the parameters associated with the multi-PxSCH configuration of the plurality of multi-PxSCH configurations based on a format of the DCI.
